(19) United States
(12) Patent Application Publication
(10) Pub. No.: US 2013/0278626 A1
(43) Pub. Date: Oct. 24, 2013

(54) SYSTEMS AND METHODS FOR SIMULATING ACCESSORY DISPLAY ON A SUBJECT

(71) Applicants: Matthew Flagg, San Diego, CA (US); Satya Mallick, San Diego, CA (US); David Kriegman, San Diego, CA (US)

(72) Inventors: Matthew Flagg, San Diego, CA (US); Satya Mallick, San Diego, CA (US); David Kriegman, San Diego, CA (US)

(21) Appl. No.: 13/451,949

(22) Filed: Apr. 20, 2012

(51) Int. Cl. G09G 5/00

(52) U.S. Cl. 345/629

(57) ABSTRACT

Systems and methods for simulating accessory display on a subject are described herein. At least one digital image of a subject is obtained. At least one target contour in an accessory target zone is identified. An accessory image and an accessory foreground matte, and a plurality of accessory control points associated with at least one contour contact zone are obtained. At least one accessory scaling factor is determined. At least one accessory registration angle is determined based on the at least one digital image. At least one simulated image is generated by registering a foreground portion of the accessory image with the at least one digital image based on the at least one accessory scaling factor, the at least one accessory registration angle, the accessory foreground matte, the at least one target contour, and the plurality of accessory control points, where registering includes applying a transformation.

### BACKGROUND OF THE INVENTION

1. Field of the Invention

Embodiments of the invention described herein pertain to the field of computer systems. More particularly, but not by way of limitation, one or more embodiments of the invention enable systems and methods for simulating accessory display on a subject.

2. Description of the Related Art

E-commerce has been steadily increasing with respect to a total market share of retail goods. Brick-and-mortar establishments offer consumers a more interactive experience. In a retail store, consumers can view goods in person. For fashion, including clothing, jewelry, and other accessories, consumers value the experience of being able to try on products.

There have been efforts to provide users an interactive e-commerce experience by allowing a user to view a simulation based on a photo of the user. Such efforts help bridge the gap between e-commerce portals and brick-and-mortar establishments, resulting in improved e-commerce sales. However, shortcomings in simulating the product on the consumer have limited the ability to provide a realistic simulation of a user wearing the product. These methods imperfectly register the product to the user photograph, resulting in artifacts.

It is also useful to simulate products on a model image. For example, simulating multiple products on a model image can reduce production costs and time over other methods, such as photographing a model wearing each product. Simulating multiple products on the same image can also generate a more consistent and desirable user experience. Users can evaluate product color, shape, texture, style, and size in a uniform environment, whether on a user-supplied photograph or on a model. However, imperfect simulations with artifacts limit the realistic simulation of products on a model image.

To overcome the problems and limitations described above, there is a need for systems and methods for simulating accessory display on a subject.

### BRIEF SUMMARY OF THE INVENTION

Systems and methods for simulating accessory display on a subject described herein enable generating an image of a subject wearing at least one accessory by realistically adding the accessory to a digital image of the subject. The accessory may be selected from hats, bracelets, necklaces, scarves, purses, handbags, backpacks, watches, jewelry, form-fitting accessories, form-fitting clothing and undergarments.

One or more embodiments of systems and methods for simulating accessory display on a subject are directed to a computer-readable medium including computer-readable instructions for simulating accessory display on a subject.

Execution of the computer-readable instructions by one or more processors causes the one or more processors to carry out steps including obtaining at least one digital image of a subject including an accessory target zone. In one or more embodiments, the accessory target zone includes a neck region.

The steps further include identifying at least one target contour in the accessory target zone of the at least one digital image. In one or more embodiments, the at least one target contour includes a left shoulder contour and a right shoulder contour.

The steps further include obtaining an accessory image including an accessory. In one or more embodiments, the accessory image includes at least one reference marker. The at least one reference marker may include at least one reference color. The accessory may be selected from hats, bracelets, necklaces, scarves, purses, handbags, backpacks, watches, jewelry, form-fitting accessories, form-fitting clothing and undergarments.

The steps further include obtaining an accessory foreground matte.

The steps further include obtaining a plurality of accessory control points associated with at least one contour contact zone.

The steps further include determining at least one accessory scaling factor. In one or more embodiments, the at least one accessory scaling factor is determined based on the at least one reference marker and at least one inter-pupillary distance in the at least one digital image.

The steps further include determining at least one accessory registration angle based on the at least one digital image of the subject.

The steps further include generating at least one simulated image by registering a foreground portion of the accessory image with the at least one digital image based on the at least one accessory scaling factor, the at least one accessory registration angle, the accessory foreground matte, the at least one target contour, and the plurality of accessory control points, where registering includes applying a transformation. In one or more embodiments, the transformation includes a 2-D image warping using a homography. In one or more embodiments, the transformation includes a moving least squares morphing image deformation.

In one or more embodiments, the steps further include determining an image color distribution of the digital image, where the registering is further based on the image color distribution.

In one or more embodiments, the steps further include obtaining at least one material movement attribute associated with at least one portion of the accessory foreground matte, where the transformation is further based on the at least one material movement attribute.

In one or more embodiments, the steps further include obtaining at least one material appearance attribute corresponding to at least one portion of the accessory foreground matte, where the generation is further based on the at least one material appearance attribute. The at least one material appearance attribute may include at least one attribute selected from the set consisting of transparency, surface angle and surface reflectivity.

The at least one digital image may include a plurality of video frames. In one or more embodiments, the steps further include obtaining at least one sway point associated with the accessory foreground matte, where the transformation is further based on the at least one sway point and at least one estimated sway position of the accessory in the plurality of video frames.

In one or more embodiments, the accessory image and the accessory foreground matte are prepared by placing the accessory on a mannequin including a transparent surface, providing backlighting with respect to an imaging device positioned to face the front chest area of the mannequin, where the backlighting is detectable through the transparent surface by the imaging device, using the imaging device to capture a full accessory image, and generating an initial accessory matte based on image intensity in the accessory image, where the accessory image includes at least a portion of the full accessory image and where the accessory foreground matte is based on the initial accessory matte. The accessory foreground matte may be manually modified. The mannequin may have a dampening portion configured to reduce movement of the accessory. At least one reference marker may be placed in a known position with respect to the mannequin. The backlighting may be configured to illuminate an area corresponding to a maximum accessory target zone.

In one or more embodiments, the steps further include iteratively refining the accessory image matte by modifying said backlighting based on a current accessory matte, obtaining at least one additional matte image of the accessory, and generating at least one additional accessory matte based on the at least one additional matte image.

In one or more embodiments, the steps further include obtaining a manual mask prepared by a user based on the full accessory image, where the manual mask overlaps with the accessory in the full accessory image, calculating the accessory image matte based on the manual mask and the initial accessory matte, iteratively refining the accessory image matte by obtaining additional matte images of the accessory, where the backlighting for the additional matte images is modified based on the accessory image matte. At least one updated full accessory image may be obtained using the modified backlighting.

In one or more embodiments, the steps further include displaying the at least one simulated image in a user interface, accepting at least one modification to at least one of the accessory scaling factor, the accessory registration angle, the inter-pupillary distance, and the at least one target contour, and generating at least one modified simulated image based on the at least one modification.

In one or more embodiments, the steps further include displaying the at least one simulated image in association with marketing material for the accessory.

In one or more embodiments, the steps further include obtaining at least one additional accessory image including at least one additional accessory, obtaining at least one additional accessory foreground matte, obtaining a plurality of additional accessory control points associated with the at least one additional accessory foreground matte, determining at least one additional accessory scaling factor, and determining at least one additional accessory registration angle based on the at least one digital image of the subject, where at least one foreground portion of the at least one additional accessory image is registered with the at least one digital image and the foreground portion of the accessory image.

One or more embodiments of systems and methods for simulating accessory display on a subject are directed to a computer-readable medium including computer-readable instructions for generating and displaying model accessory images. Execution of the computer-readable instructions by one or more processors causes the one or more processors to carry out steps including obtaining a model image including a neck and upper chest region of a subject, obtaining a left shoulder contour and a right shoulder contour of the subject in the model image, obtaining an accessory image of an accessory for a neck area, obtaining an accessory foreground matte defining a foreground region of the accessory in the accessory image, obtaining a plurality of accessory control points associated with at least one contour contact zone, generating a simulated image by registering a foreground portion of the accessory image with the model image based on the accessory foreground matte, the at least one target contour, and the plurality of accessory control points, where registering includes applying a transformation based on the plurality of accessory control points and the at least one target contour, and displaying the simulated image in association with marketing material for the accessory.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates a general-purpose computer and peripherals that when programmed as described herein may operate as a specially programmed computer capable of implementing one or more methods, apparatus and/or systems in accordance with systems and methods for simulating accessory display on a subject.

FIGS. 2A-2C illustrate potential artifacts in accordance with systems and methods for simulating accessory display on a subject.

FIG. 3 illustrates an exemplary subject in accordance with systems and methods for simulating accessory display on a subject.

FIG. 4 illustrates an exemplary setup for obtaining an accessory image in accordance with systems and methods for simulating accessory display on a subject.

FIGS. 5A-5D illustrate exemplary intermediate image processing products in accordance with systems and methods for simulating accessory display on a subject.

FIG. 6A-6C illustrate exemplary reference curve data in accordance with systems and methods for simulating accessory display on a subject.

FIG. 7A-7E illustrates exemplary intermediate matte calculation products in accordance with systems and methods for simulating accessory display on a subject.

FIG. 8 illustrates an exemplary histogram in accordance with systems and methods for simulating accessory display on a subject.

FIG. 9 illustrates a flowchart of an exemplary process for simulating display of an accessory in accordance with systems and methods for simulating accessory display on a subject.

FIG. 10 illustrates a flowchart of an exemplary process for generating accessory images, accessory foreground mattes and accessory control points in accordance with systems and methods for simulating accessory display on a subject.

FIG. 11 illustrates a flowchart of an exemplary process for iterative matte refining in accordance with systems and methods for simulating accessory display on a subject.

FIG. 12 illustrates a flowchart of an exemplary process for simulating display of an additional accessory in accordance with systems and methods for simulating accessory display on a subject.

FIG. 13 illustrates a flowchart of an exemplary process for simulating display of at least one accessory on a model in accordance with systems and methods for simulating accessory display on a subject.

### DETAILED DESCRIPTION

Systems and methods for simulating accessory display on a subject will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary kill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

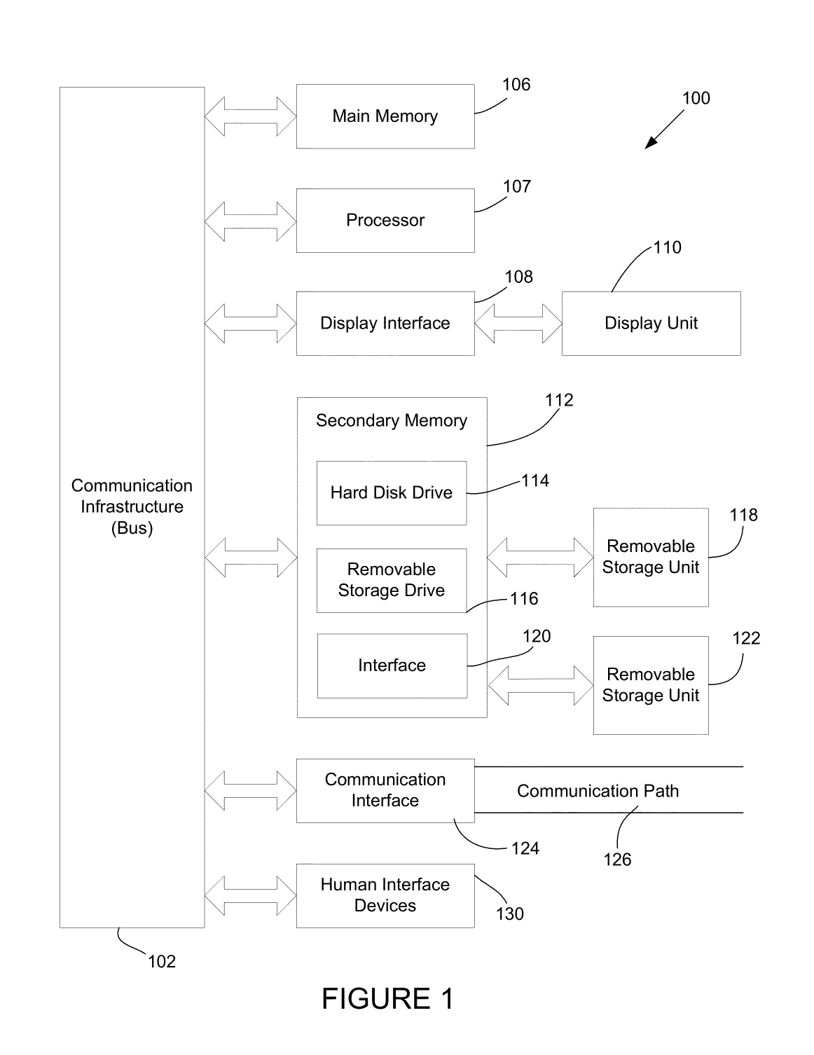

FIG. 1 diagrams a general-purpose computer and peripherals, when programmed as described herein, may operate as a specially programmed computer capable of implementing one or more methods, apparatus and/or systems of the solution described in this disclosure. Processor 107 may be coupled to bi-directional communication infrastructure 102 such as communication infrastructure system bus 102. Communication infrastructure 102 may generally be a system bus that provides an interface to the other components in the general-purpose computer system such as processor 107, main memory 106, display interface 108, secondary memory 112 and/or communication interface 124.

Main memory 106 may provide a computer readable medium for accessing and executed stored data and applications. Display interface 108 may communicate with display unit 110 that may be utilized to display outputs to the user of the specially-programmed computer system. Display unit 110 may comprise one or more monitors that may visually depict aspects of the computer program to the user. Main memory 106 and display interface 108 may be coupled to communication infrastructure 102, which may serve as the interface point to secondary memory 112 and communication interface 124. Secondary memory 112 may provide additional memory resources beyond main memory 106, and may generally function as a storage location for computer programs to be executed by processor 107. Either fixed or removable computer-readable media may serve as Secondary memory 112. Secondary memory 112 may comprise, for example, hard disk 114 and removable storage drive 116 that may have an associated removable storage unit 118. There may be multiple sources of secondary memory 112 and systems implementing the solutions described in this disclosure may be configured as needed to support the data storage requirements of the user and the methods described herein. Secondary memory 112 may also comprise interface 120 that serves as an interface point to additional storage such as removable storage unit 122. Numerous types of data storage devices may serve as repositories for data utilized by the specially programmed computer system. For example, magnetic, optical or magnetic-optical storage systems, or any other available mass storage technology that provides a repository for digital information may be used.

Communication interface 124 may be coupled to communication infrastructure 102 and may serve as a conduit for data destined for or received from communication path 126. A network interface card (NIC) is an example of the type of device that once coupled to communication infrastructure 102 may provide a mechanism for transporting data to communication path 126. Computer networks such Local Area Networks (LAN), Wide Area Networks (WAN), Wireless networks, optical networks, distributed networks, the Internet or any combination thereof are some examples of the type of communication paths that may be utilized by the specially program computer system. Communication path 126 may comprise any type of telecommunication network or interconnection fabric that can transport data to and from communication interface 124.

To facilitate user interaction with the specially programmed computer system, one or more human interface devices (HID) 130 may be provided. Some examples of HIDs that enable users to input commands or data to the specially programmed computer may comprise a keyboard, mouse, touch screen devices, microphones or other audio interface devices, motion sensors or the like, as well as any other device able to accept any kind of human input and in turn communicate that input to processor 107 to trigger one or more responses from the specially programmed computer are within the scope of the system disclosed herein.

While FIG. 1 depicts a physical device, the scope of the system may also encompass a virtual device, virtual machine or simulator embodied in one or more computer programs executing on a computer or computer system and acting or providing a computer system environment compatible with the methods and processes of this disclosure. In one or more embodiments, the system may also encompass a cloud computing system or any other system where shared resources, such as hardware, applications, data, or any other resource are made available on demand over the Internet or any other network. In one or more embodiments, the system may also encompass parallel systems, multi-processor systems, multi-core processors, and/or any combination thereof. Where a virtual machine, process, device or otherwise performs substantially similarly to that of a physical computer system, such a virtual platform will also fall within the scope of disclosure provided herein, notwithstanding the description herein of a physical system such as that in FIG. 1.

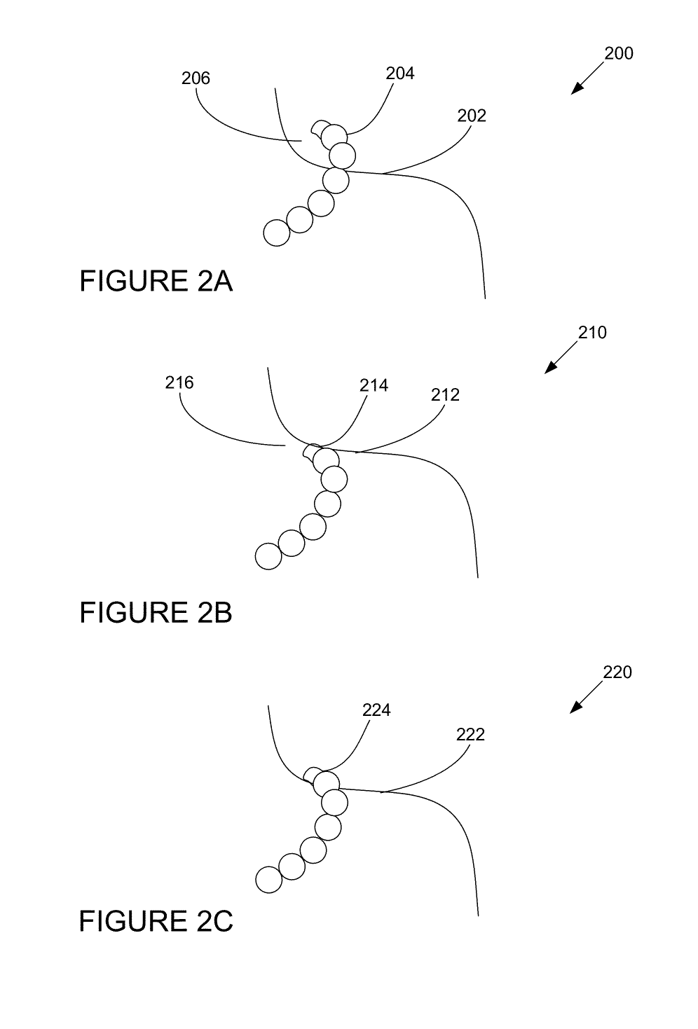

A key step to achieving photorealism is to properly align the accessory to a subject contour in an image of the subject where the accessory contacts the subject contour. Misalignment results in artifacts including gaps and overlaps between the necklace and body. FIG. 2A illustrates a potential gap artifact resulting from misalignment of an accessory displayed on a subject. Simulated image 200 shows accessory 204 simulated on a subject. A gap artifact 206 is present between accessory 204 and subject contour 202. FIG. 2B illustrates a potential overlap artifact resulting from misalignment of an accessory displayed on a subject. Simulated image 210 shows accessory 214 simulated on a subject. An overlap artifact 216 is present between accessory 214 and subject contour 212. FIG. 2C illustrates an ideal alignment of a simulated accessory displayed on the subject. Simulated image 220 shows accessory 224 properly aligned with subject contour 222.

An ideal alignment requires uniform scaling and translation of the accessory to roughly place the accessory on the subject image. Point correspondence estimation between an accessory contact zone and at least one subject contour is performed, and the initially placed accessory is warped to eliminate artifacts at the contact point between the accessory contact zone and the subject contour. In one or more embodiments, the accessory image is modified while keeping the accessory as rigid as possible. This eliminates artifacts such as gap artifact 206 and overlap artifact 216.

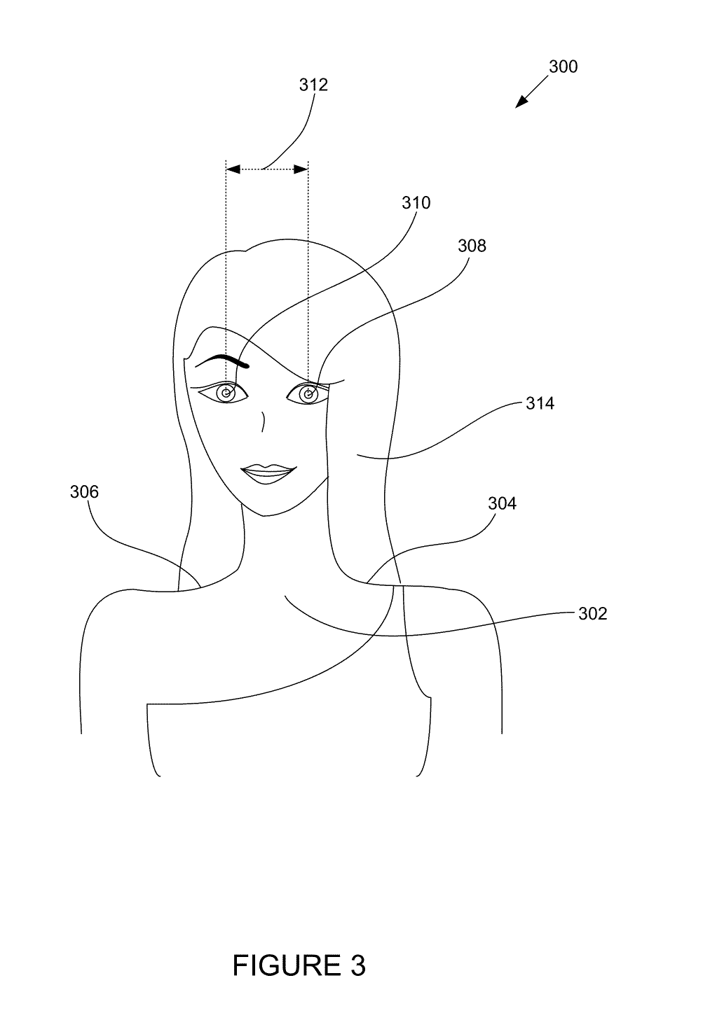

FIG. 3 illustrates an exemplary subject in accordance with systems and methods for simulating accessory display on a subject. Subject image 300 is a digital image of a subject. In one or more embodiments, the subject image 300 is a digital image of the subject in a front facing position showing a neck, shoulder and chest region. The at least one digital image includes a plurality of video frames containing the subject and the accessory target zone. One or more sway points and/or sway periods may be used to stimulate the motion of an accessory over time in the plurality of video frames.

Subject image 300 includes pupils 308-310. Inter-pupillary distance (IPD) 312 is calculated by the distance between pupils 308-310. Inter-pupillary distance 312 may be calculated by using computational methods to detect pupils 308-310 in subject image 300. The inter-pupillary distance is roughly constant among women (mean IPD is 62.31 mm with a standard deviation of 3.599 mm) and thus serves as a reference measurement for scaling for frontal images of arbitrary subjects. Inter-pupillary distance 312 may be used as a scale estimate to determine the proper scaling of an accessory simulated on subject image 300. Therefore, at least one accessory scaling factor may be based on inter-pupillary distance 312.

Subject image 300 further includes at least one accessory target zone 302. Accessory target zone 302 includes the region of the subject where the display of an accessory will be simulated. For example, accessory target zone 302 may include a neck region, a shoulder region, an arm region, a head region, a neck region, a chest region a torso region, a hand region, a buttock region, a leg region, a foot region, and any other region suitable for wearing an accessory, including any combination thereof. In one or more embodiments, accessory target zone 302 includes the neck and chest region for a neck accessory, such as a necklace, a choker, a scarf, a chain, a tie, or any other accessory suitable for wearing on the neck area.

Subject image 300 further includes at least one subject contour 304-306. When an accessory is simulated on the subject, a visible portion of the accessory is displayed in the simulated image, while a hidden portion of the accessory is not. Subject contour 304-306 identifies a boundary of the subject that is related to the visible portion and the hidden portion of the accessory.

In one or more embodiments, the at least one target contour includes a left shoulder contour and the right shoulder contour. A shoulder contour may include any portion of a shoulder line, a neck line, and any combination thereof. Any subject contour 304-306 may be represented as a set of ordered points identifying a piecewise linear curve, as one or more curves describable by a formula, a spline, or any combination thereof.

In one or more embodiments, a subject contour is 304-306 is automatically calculated from subject image 300, such as by using an image processing technique, algorithm and/or heuristic. An automatically calculated subject contour 304-306 may be manually modified. A subject contour 304-306 may also be manually provided.

Subject image 300 further includes the subject's hair 314. In one or more embodiments, subject image 300 is obtained such that the subject hair 314 does not occlude any subject contour 304-306.

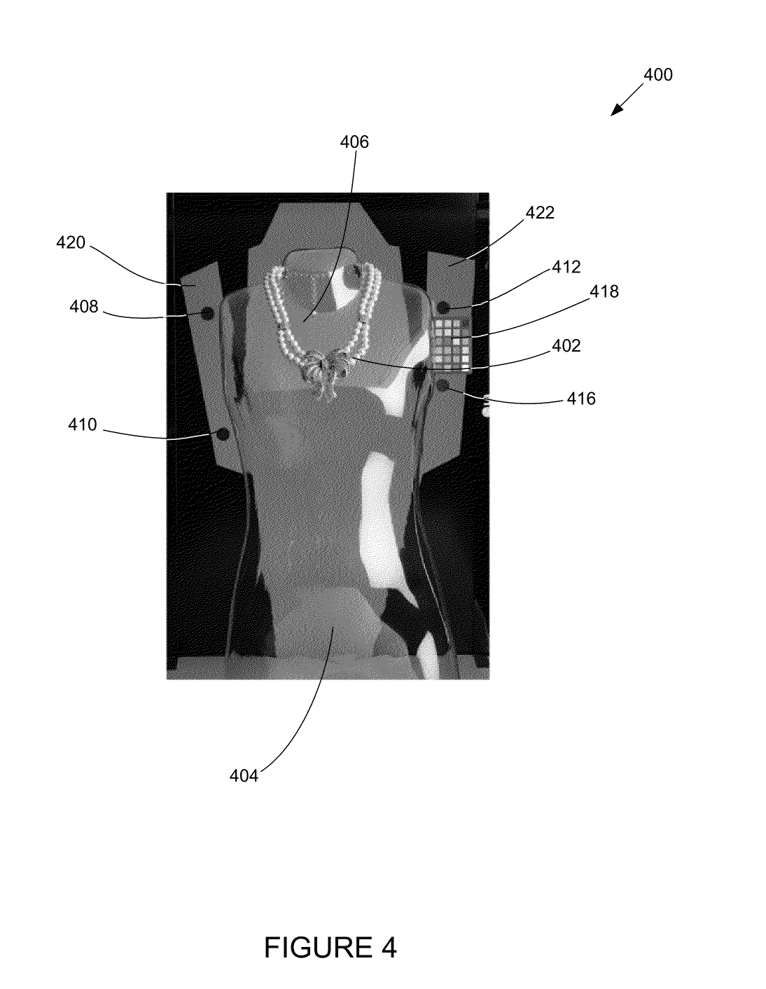

FIG. 4 illustrates an exemplary setup for obtaining an accessory image in accordance with systems and methods for simulating accessory display on a subject. Full accessory image 400 is a color image of accessory 402. Accessory 402 is placed on mannequin 404. Mannequin 404 may include any object suitable for substituting a subject wearing an accessory. Although the mannequin may resemble a human form, any form suitable for approximating the wearing of an accessory by a subject may be used. In one or more embodiments, the mannequin is made of one or more skeletal forms configured to hold or suspend the accessory in the proper position, thereby approximating the wearing of the accessory by a subject. The skeletal forms may include wire, thread, glass, plastic, acrylic, nylon, synthetic or natural fibers, or any combination thereof.

At least a portion of the mannequin may have transparent surface 406. In one or more embodiments, at least a portion of accessory 402 rests on transparent surface 406. For example, the portion of accessory 402 that rests on transparent surface 406 may include a foreground portion of accessory 402 typically appearing on top of a subject in a photograph.

At least one reference marker 408-418 of a known color and/or known position and/or known orientation relative to the mannequin may be placed on or near mannequin 404 such that reference markers 408-418 are captured in full accessory image 400. Reference markers 408-418 may relate to position, orientation, color, or any other objective characteristic of accessory 402. Reference markers 408-418 may be used to determine a distance, orientation, color adjustment between any accessory image and any subject image. For example, an accessory scaling factor may be calculated based on at least one reference marker.

In one or more embodiments, reference markers 408-418 include two sets of reference objects located in a known position relative to mannequin 404 to support acquisition of geometric and photometric characteristics of accessory 402. The first set of reference objects includes four markers 408-416 mounted to at least one transparent backing 420-422. Transparent backing 420-422 may be coupled with mannequin 404. In one or more embodiments, mannequin 404 is a shell facing an imaging device, and mannequin 404 is positioned in a vertical plane facing the imaging device, enabling the mannequin's pose relative to the imaging device to be represented using a homography (projective transformation), or plane-to-plane mapping in 3D. The four markers 408-416 and transparent backing 420-422 are mounted in the coronal plane of the mannequin and distributed to the corners and out of the way of the largest expected accessory 402. The four markers 408-416 are easily detected and recognized using one or more image processing techniques, algorithms and/or heuristics. Reference markers 408-416 may be detected automatically in a full accessory image using one or more image processing techniques, algorithms and/or heuristics. In one or more embodiments, a user may review and/or correct a location of a reference marker in full accessory image 400.

Reference markers 408-418 may also include a color chart 418, such as a mini Macbeth color chart (X-rite ColorChecker) whose appearance in the color picture gives photometric responses of known color samples and may be used for color correction while virtually simulating an accessory in different subject images.

In one or more embodiments, accessory 402 is a neck accessory, such as a a necklace, a choker, a scarf, a chain, a tie, or any other accessory suitable for wearing on the neck area. Full accessory image 400 is a front-facing view of the necklace in a natural pose for draping onto the shoulders of a subject. Mannequin 404 may be a transparent shell shapes to represent the neck, shoulder and chest region of a human. In one or more embodiments, mannequin 404 is shaped in a female form featuring average-sized breasts with little cleavage and a stomach that protrudes from a vertical plane facing the imaging device. Based on this configuration of mannequin 404, neck accessory 402 is allowed to slide inward towards the cleavage as would normally be expected. Furthermore, free hanging motions are minimized because the configuration dampens movement of longer neck accessories 402. Free hanging motions can result in misalignment between full accessory image 400 and additional images acquired to generate an accessory foreground matte.

In one or more embodiments, the curvature of mannequin 404 is designed to minimize refraction of a backlight source located behind mannequin 404. In one or more embodiments, mannequin 404 is configured to minimize attenuation of a backlight source shining through transparent surface 406. For example, a curvature of transparent surface 406 may be minimized to reduce refraction.

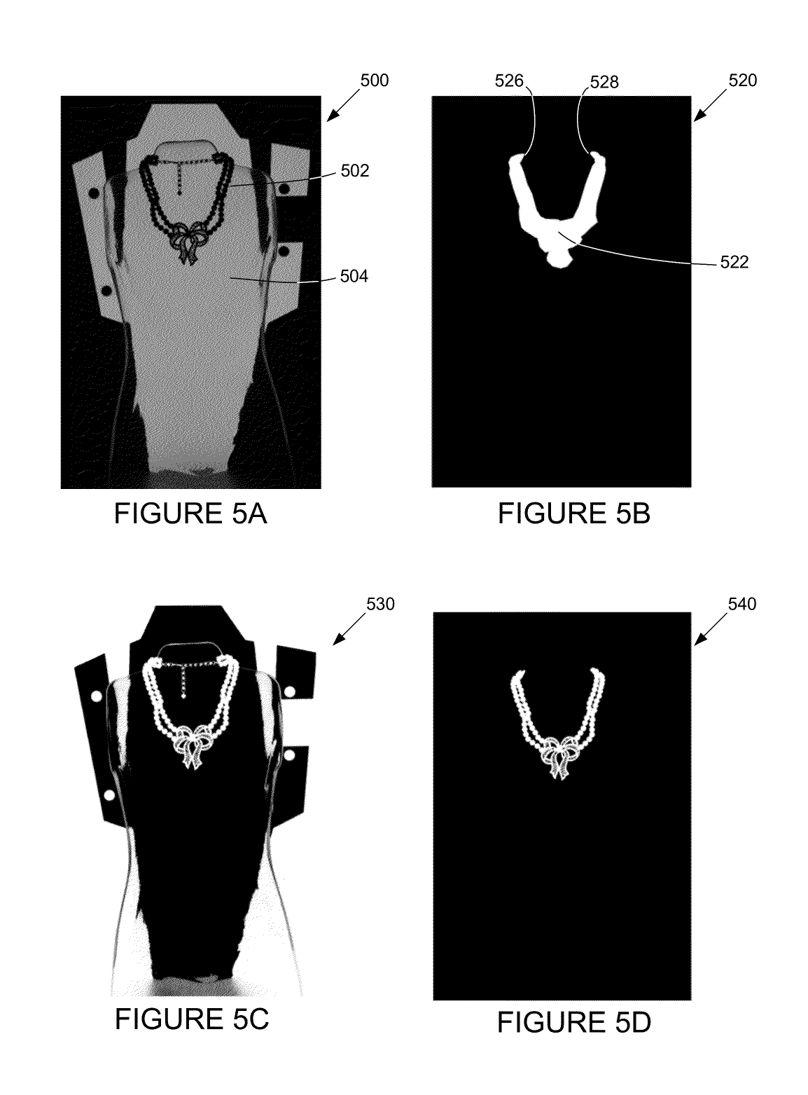

Full accessory image 400 is obtained using the imaging device. Standard photographic lights, including soft boxes and spotlights, maybe positioned and aimed with modeling lights to stylize the appearance of accessory 402 in the imaging device's view. The imaging device may be configured to take two images in rapid succession: full accessory image 400 and an original matte image (see FIG. 5A). In one example, a Nikon D300 camera is used in continuous burst mode, which enables the capture of 8 pictures per second. Full accessory image 400 is captured with all studio lights on and the backlight off while the original matte image is taken with all lights off except backlighting (see FIG. 5A).

FIGS. 5A-5D illustrate exemplary intermediate image processing products in accordance with systems and methods for simulating accessory display on a subject.

FIG. 5A illustrates an exemplary original matte image in accordance with systems and methods for simulating accessory display on a subject. In one or more embodiments, original matte image 500 is captured immediately after capturing full accessory image 400.

Original matte image 500 may be captured using backlighting. In one or more embodiments, the backlighting, provided by at least one backlight source, is the only source of light when original matte image 500 is captured. A backlight source may include any source of light located behind mannequin 504 with respect to an imaging device, including any backlight source use in the field of photography. The backlight source may be positioned directly behind a transparent surface on which the accessory rests, even if a portion of the accessory (such as a portion of the accessory that is typically hidden in a photograph of a subject wearing the accessory) is positioned behind the backlight. In one or more embodiments, the backlight source is highly controllable. For example, a monitor positioned behind mannequin 504 may be used to display backlighting with adjustable intensities and/or patterns. In one or more embodiments, the monitor may include a mobile device monitor, such as a laptop, phone, PDA, smartphone, or other monitor. The mobile device monitor may be held inside or behind a transparent surface on which the accessory rests.

In one or more embodiments, backlighting with adjustable intensities and/or patterns is used to iteratively refine an accessory foreground matte. Iterative matte refining is used to eliminate false transparency artifacts caused by reflections of the backlight off the accessory and into the imaging device. This is particularly useful when the accessory has a reflective surface. False transparency artifacts are more likely to occur when the backlight covers a wide area behind the accessory. Light rays which reflect off curved edges of an accessory are more likely to be captured by imaging device as the light source moves away from the accessory's edge in the image plane. An initial alpha matte with possible false transparency artifacts may be automatically improved by thresholding the alpha matte to make it binary, hole-filling and dilating with morphological operators, displaying a reduced lighting pattern on the backlight in place of the initial backlight pattern, and reshooting original matte photo 500. Full accessory image 400 may also be recaptured, such as use by using the rapid capture techniques described herein. Histogram data may be used to modify imaging device settings when recapturing full accessory image 400, such as to improve image quality of full accessory image 400.

In one or more embodiments where iterative matte calculation is used, the accessory is backlit with a refined alpha matte image is to align the pattern directly behind the accessory from the perspective of the imaging device. This may be achieved by computing a camera-to-display homography using four point correspondences between the monitor and the imaging device. Following homography estimation, the post-processed alpha matte is warped under the camera-to-display homography and displayed on the TV monitor. Initial mask 520 may be reused when iterative matte calculation is performed.

In one or more embodiments, a binary black/white pattern on a monitor is used to provide backlighting directly behind accessory 502. The monitor may include any lighted display, including an LCD display, cathode ray tube, plasma screen, LED display, projector, and any other display device capable of displaying light in accordance with the systems and methods described herein. To avoid reflections off the occluding contours of accessory 502, a pattern that is tightly bound to accessory 502 minimizes the potential artifacts from such reflection. Any other backlighting pattern may be used, such as a uniform lighting, radial lighting, and a pattern based on the shape of mannequin 504, a pattern based on the actual size and/or shape of accessory 502, and any other pattern or combination thereof. The backlight pattern may be modified for different accessories, different orientations of the same accessory, subsequent iterations to refine a matte, and for any other purpose. In one or more embodiments, a computing device communicatively coupled with the imaging device and at least one backlight source may be used to control backlight intensity, pattern, and timing.

Where the only light source is the monitor, the intensity of light in original matte image 500 is approximately proportional to visibility of accessory 502, providing information on the opacity of accessory 502. The light intensity in original matte image 500 is also affected by the backlight source intensity and pattern as well as refraction away from the camera's viewpoint caused by surface of mannequin 504.

FIG. 5B illustrates an exemplary initial mask in accordance with systems and methods for simulating accessory display on a subject. Initial mask 520 indicates a visible portion of an accessory when worn by a subject. For example, a portion of an accessory positioned behind the mannequin will be excluded from initial mask 520. Initial mask 520 may be computationally generated, manually generated, or a combination thereof.

In one or more embodiments, initial mask 520 is manually generated by a user from a full accessory image, such as full accessory image 400. The user is presented with the full accessory image for the purpose of identifying the visible portions of the necklace. A commercial photo editing application (e.g. Adobe Photoshop CS4) may be used to perform the masking in order to exploit a wide range of interactive masking tools that are familiar to professionals. Masking may be performed using a mixture of polygons, useful for quickly masking at a coarse level, and curves, which provide a greater level of detail.

In one or more embodiments, detailed masking is performed at one or more contour contact zones 526-528. A contour contact zone identifies a foreground portion of the accessory image that will be aligned with at least one target contour. At least a portion of accessory 522 may fall behind an occluding boundary of the mannequin. This portion of accessory 522 would be positioned behind a subject in a simulated display of the subject wearing accessory 522. For example, for a neck accessory, the contour contact zones 526-528 will be aligned with a left shoulder contour and a right shoulder contour in a digital image of a subject. Coarse masking may be used for portions of the accessory that are further away from contour contact zones 526-528.

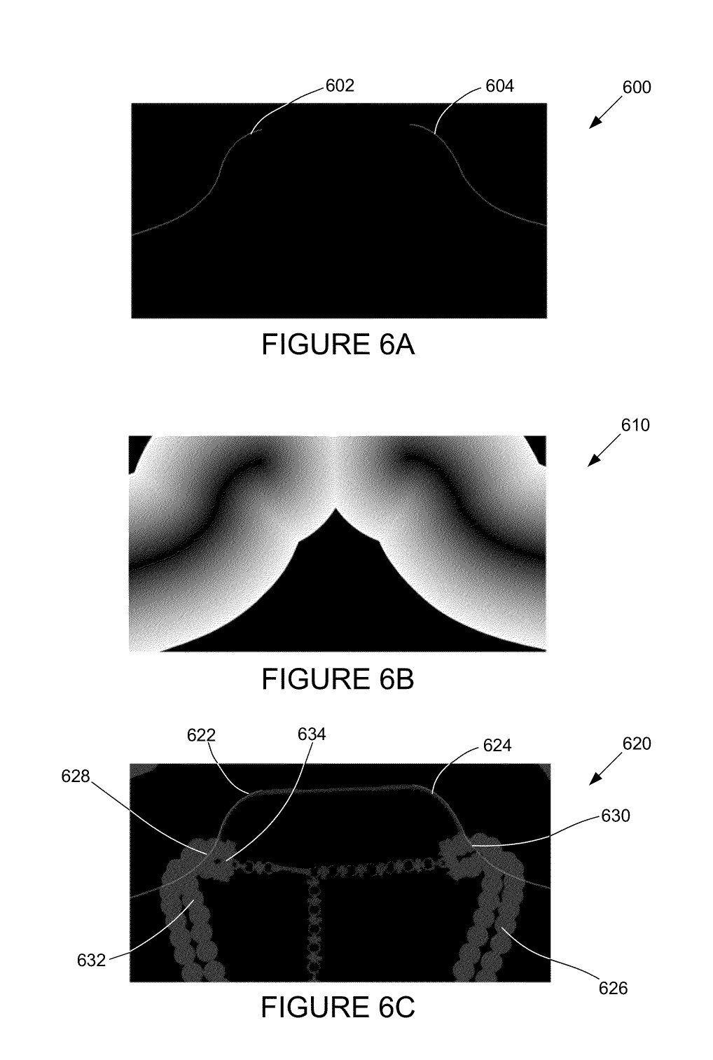

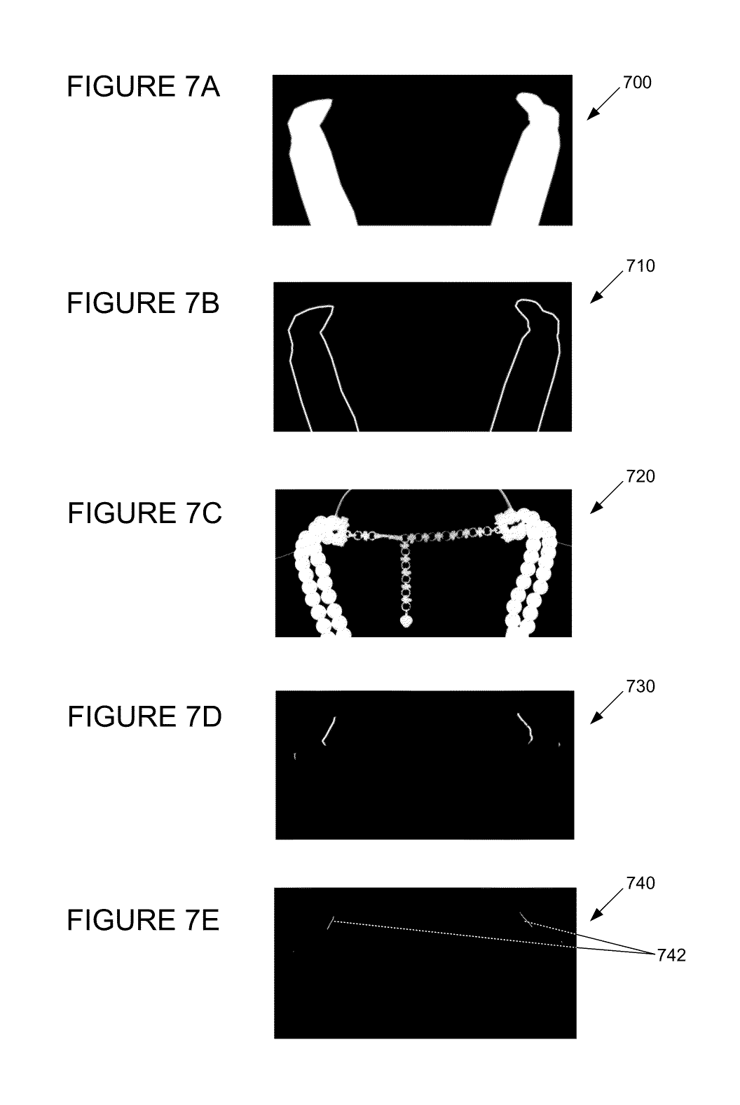

The portion of initial mask 520 aligned with the occluding boundary of the mannequin at accessory contact zones 526-528 may be later exploited in the processing stage to determine correspondences between the accessory at accessory contact zone 526-528 and at least one target contour of a subject (See FIGS. 6A-6C and 7A-7E).

FIG. 5C illustrates an exemplary processed matte image in accordance with systems and methods for simulating accessory display on a subject. To generate processed matte image 530, one or more image processing techniques, algorithms and/or heuristics are performed on an original matte image, such as original matte image 500. For example, one or more of homography estimation, thresholding, color inversion and any other image processing techniques suitable for generating a matte from the original matte image 500 captured by the imaging device may be used. Processed matte image 530 is an exemplary intermediate product between original matte image 500 and accessory foreground matte 540. In one or more embodiments, accessory foreground matte 540 may be generated from original matte image 500 without generating this intermediate product as an output (i.e. processed matte image 530) without departing from the spirit or the scope of the invention.

FIG. 5D illustrates an exemplary accessory foreground matte in accordance with systems and methods for simulating accessory display on a subject. Accessory foreground matte 540 is a final matte used for rendering the simulation of the subject wearing the accessory.

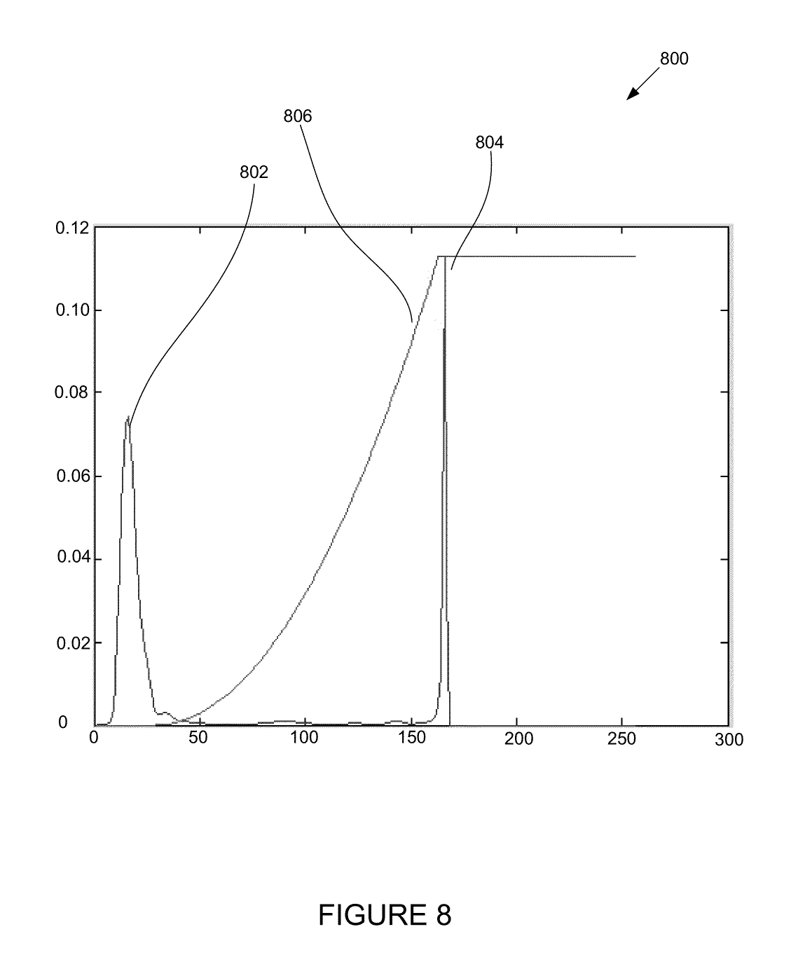

In one or more embodiments, accessory foreground matte 540 is generated from processed matte image 530 and initial foreground matte 520. A histogram of intensities is computed on the output of a pixel-wise multiplication of processed matte image 530 with initial foreground matte 520. FIG. 8 illustrates an exemplary histogram in accordance with systems and methods for simulating accessory display on a subject. Histogram 800 has two well-defined modes 802-804 corresponding to dark and bright pixels. In one or more embodiments, a Gaussian smoothing operation is applied to histogram 800, and the mean bin value is applied as a threshold to segment histogram 800 into bright and dark modes and produce an accessory foreground matte that is binary. A transfer function 806 may be, is constructed over the domain starting at bin i of the histogram where the first mode has dropped to bin j of the histogram where the second mode begins to rise. In one or more embodiments, transfer function 806 is proportional to the nonlinear transfer function mapping y=max(0, min(1, ((x−i)/(j−i))²)). Normalized accessory foreground matte 540 that is grayscale is computed by applying this transfer function to the masked matte.

FIG. 6A-6C illustrate exemplary reference curve data in accordance with systems and methods for simulating accessory display on a subject. Accurate depiction of the junction between the accessory and the subject at the occluding boundary is essential to achieving photorealistic simulation of the accessory on the subject.

FIG. 6A illustrates an exemplary reference curve in accordance with systems and methods for simulating accessory display on a subject. Reference calibration photo 600 is used to establish a universal coordinate system that all accessory images are aligned to using a homography. Within reference calibration photo 600, at least one reference curve 602-604 is drawn along the mannequin contour.

FIG. 6B illustrates an exemplary distance transform image in accordance with systems and methods for simulating accessory display on a subject. The distance transform of a reference curve 602-604 indicates a pixel distance to the reference curve 602-604. Distance transform image 610 may be pre-computed to efficiently look up any registered necklace pixel's distance to the mannequin contour when determining accessory control points (see FIGS. 7A-7E).

FIG. 6C illustrates an exemplary reference curve superimposed on an accessory matte image in accordance with systems and methods for simulating accessory display on a subject. Superimposed image 620 includes reference curves 622-624 and accessory 626. Reference curves 622-624 are associated with the boundary of the mannequin. A foreground portion 632 of accessory 626 falls in front of the mannequin, while a background portion 634 falls behind the mannequin. At least one contour contact zone 628-630 identifies a portion of accessory 626 that will be aligned with at least one target contour of the subject image based on a plurality of accessory control points. Accessory control points should be detected from contour contact zones 628-630, or the segment of the accessory-shoulder junction of the background portion 634 of accessory 626 that falls behind the mannequin.

FIG. 7A-7E illustrates exemplary accessory control point determination in accordance with systems and methods for simulating accessory display on a subject. FIG. 7A illustrates an exemplary initial mask 700 in accordance with systems and methods for simulating accessory display on a subject. FIG. 7B illustrates an exemplary edge detection product in accordance with systems and methods for simulating accessory display on a subject. Mask edge 710 is generated from initial mask 700 using any image processing technique, algorithm or heuristic suitable for edge detection. FIG. 7C illustrates an exemplary processed matte image 700 in accordance with systems and methods for simulating accessory display on a subject.

FIG. 7D illustrates exemplary potential contour contact zones in accordance with systems and methods for simulating accessory display on a subject. Initial mask 700 cuts the accessory exactly along a curve where a portions of an accessory (e.g. background portion 634) falls behind the mannequin. Therefore, potential contour contact zones 730 may be calculated by multiplying a foreground matte of the accessory, such as processed matte image 720, with edge detection product 710. At this stage, the potential contour contact zones 730 may include pixels that do not lie on a reference curve drawn on the mannequin's contour, such as reference curve 602-604. When sampling the distance of foreground pixels to mannequin contour in C_{d}, those that lie outside a threshold distance t from the reference curve may be rejected.

FIG. 7E illustrates exemplary refined contour contact zones in accordance with systems and methods for simulating accessory display on a subject. Refined contour contact zones 740 may be generated by evaluating a distance between pixels of potential contour contact zones 730 from a reference curve, such as reference curves 602-604. A distance transform image, such as distance transform image 610, may be used to facilitate the generation of refined contour contact zones 740. Refined contour contact zones 740 include inlier pixels 742 that meet the threshold distance t. In one or more embodiments, the initial estimate of homography is refined before determining refined contour contact zones 740. A homography may be refined by obtaining more accurate correspondences between input and output marker locations. Marker correspondences may be established by template matching each input marker to its matching marker in the output. Template matching is performed using normalized cross correlation on marker-centered patches of pixels.

To generate accessory control points, inlier pixels 742 of refined contour contact zones 740 are subsampled to produce a set of accessory control points. In one or more embodiments, a greedy selection process is used to subsample the accessory control points. Inlier pixels 742 are sorted in contour-following order then uniformly subsampled in a single pass. Any number of accessory control points may be used in accordance with the systems and methods described herein. In one or more embodiments, between about 5 to about 200 accessory control points may be determined for each reference curve. In one or more embodiments, the accessory is a neck accessory, between about 10 to about 30 accessory control points are determined for each reference curve corresponding to a shoulder contour.

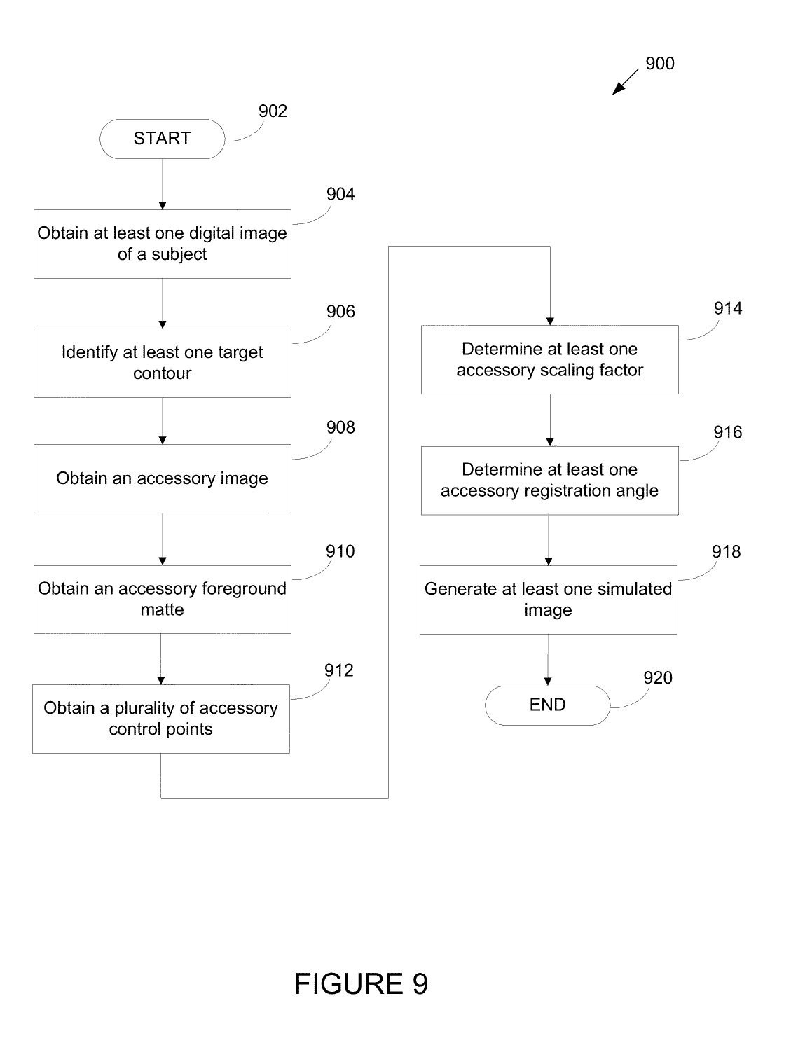

FIG. 9 illustrates a flowchart of an exemplary process for simulating display of an accessory in accordance with systems and methods for simulating accessory display on a subject. Process 900 begins at step 902.

Processing continues to step 904, where at least one digital image of a subject is obtained. The digital image of the subject includes an accessory target zone. The accessory target zone includes the region of the subject where the display of the accessory will be simulated. For example, the accessory target zone may include a neck region, a shoulder region, an arm region, a head region, a neck region, a chest region a torso region, a hand region, a buttock region, a leg region, a foot region, and any other region suitable for wearing an accessory, including any combination thereof. In one or more embodiments, the at least one digital image includes a plurality of video frames containing the subject and the accessory target zone. The digital image of the subject may be obtained from a station set up for the purpose. For example, a kiosk or other station may be set up at a retail establishment or any other location.

Processing continues to step 906, where at least one target contour is identified in the accessory target zone of the digital image of the subject. In one or more embodiments, the at least one target contour includes a left shoulder contour and the right shoulder contour.

Processing continues to step 908, where an accessory image is obtained. The accessory image includes an accessory that will be simulated on the subject.

Processing continues to step 910, where an accessory foreground matte is obtained. The accessory foreground matte includes data that identifies a foreground portion of the accessory image that contains the accessory.

Processing continues to step 912, where a plurality of accessory control points is obtained. The plurality of accessory control points is associated with at least one contour contact zone associated with the accessory. A contour contact zone identifies a foreground portion of the accessory image that will be aligned with at least one target contour. The contour contact zone may be a curve, an edge, any non-linear line, an area, or any combination thereof.

Processing continues to step 914, where at least one accessory scaling factor is determined. The accessory scaling factor reflects the relative size of the accessory to the size of the subject in the digital image. In one or more embodiments, the accessory image includes at least one reference marker from which the accessory scaling factor may be calculated. In one or more embodiments, the accessory scaling factor is determined based on an inter-pupillary distance of the subject in the at least one digital image.

The scaling factor may also be determined using information from outside the image. For example, where the digital image is obtained from a station set up for the purpose, a sensor may be used for determining the scaling rather than using the data present in the digital image. Where more than one digital image of the subject is processed, the accessory scaling factor may change between digital images.

Processing continues to step 916, where at least one accessory registration angle is determined. The accessory registration angle reflects the relative orientation of the accessory to the orientation of the subject in the digital image. In one or more embodiments, the at least one accessory registration angle is determined based on the location of the at least one target contour of the subject. Where more than one digital image of the subject is processed, the accessory registration angle may change between digital images. Furthermore, an accessory may include multiple portions that can have a different accessory registration angle. For example, an accessory that includes a hanging portion may have a different accessory registration angle for the hanging portion. The accessory registration angle may be associated with either or both of the accessory image and the digital image of the subject.

Processing continues to step 918, where at least one simulated image is generated. The simulated image is generated by registering a foreground portion of the accessory image with the at least one digital image of the subject. The at least one accessory scaling factor, at least one accessory registration angle, accessory foreground matte, at least one target contour, and plurality of accessory control points are used to generate the at least one simulated image. In one or more embodiments, the simulated image is generated using a compositing process of a subject image and a warped accessory image using a warped accessory foreground matte, where the warping is determined based on the plurality of accessory control points. In one or more embodiments, the placement of the accessory image with respect to the subject image is based on uniform scaling and translation to rigidly place the accessory on the subject image followed by non-rigidly warping of the accessory image layer to corresponding necklace-shoulder contact points. (See Example 2 for an exemplary, non-limiting implementation). The simulated image may be a weighted combination of the foreground colors in the accessory image and the background colors in the subject image. In one or more embodiments, compositing includes alpha blending, such as by applying the formula alpha*accessory image+(1−alpha)*subject image, where alpha values are determined based on the accessory foreground matte, rescaled to the range of 0 to 1.

Processing continues to step 920, where process 900 terminates.

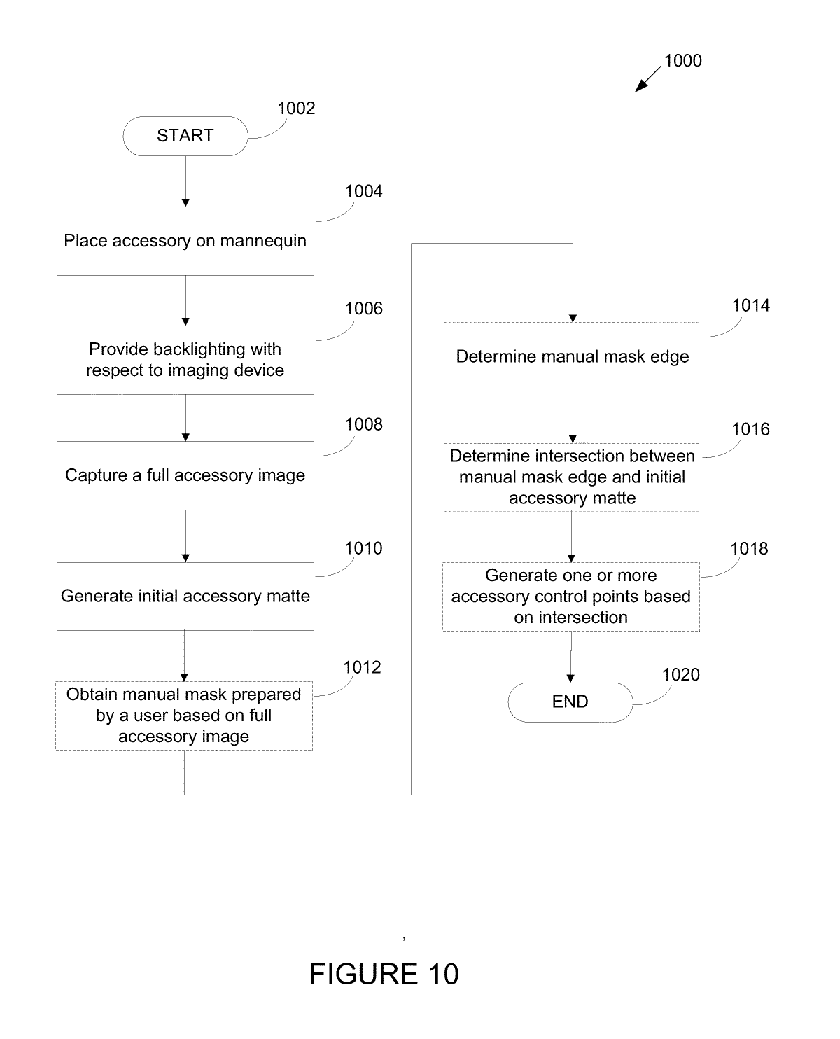

FIG. 10 illustrates a flowchart of an exemplary process for generating accessory images, accessory foreground mattes and accessory control points in accordance with systems and methods for simulating accessory display on a subject. Process 1000 begins at step 1002.

Processing continues to step 1004, where an accessory is placed on a mannequin. The mannequin may include any object suitable for substituting a subject wearing an accessory. Although the mannequin may resemble a human form, in a form suitable for approximating the wearing of an accessory by a subject may be used. At least a portion of the mannequin may have a transparent surface.

Processing continues to step 1006, where backlighting is provided with respect to an imaging device. The imaging device is positioned to face a front side of the mannequin. In one or more embodiments, the imaging device is positioned to face the front chest area of the mannequin. The backlighting is detectable through the transparent surface of the mannequin by the imaging device.

Processing continues to step 1008, where a full accessory image is captured using the imaging device. The full accessory image may include at least one reference marker of a known color and/or position relative to the mannequin. As used herein, the term full accessory image refers to an image that includes both a foreground portion corresponding to the accessory, as defined by a matte, and any additional background portion. Therefore, a full accessory image may refer to a clipped or cropped version of the image captured by the imaging device.

Processing continues to step 1010, where an initial accessory matte is generated. The initial accessory matte includes at least a portion of the full accessory image. In one or more embodiments, the initial accessory matte is generated based on image intensity in the accessory image. For example, a histogram may be used to detect the backlighting, and the initial accessory matte may include darker regions of the full accessory image.

Processing continues to optional step 1012, where a manual mask is obtained. The manual mask is prepared by a user based on a full accessory image.

Processing continues to optional step 1014, where a manual mask edge is determined. The manual mask edge is determined based on the manual mask. Image processing techniques, such as known edge detection techniques, may be used to determine the manual mask edge.

Processing continues to optional step 1016, where an intersection between the manual mask edge and the initial accessory matte is determined.

Processing continues to optional step 1018, where one or more accessory control points are generated based on the intersection between the manual mask edge and initial accessory matte.

Processing continues to step 1020, where process 1000 terminates.

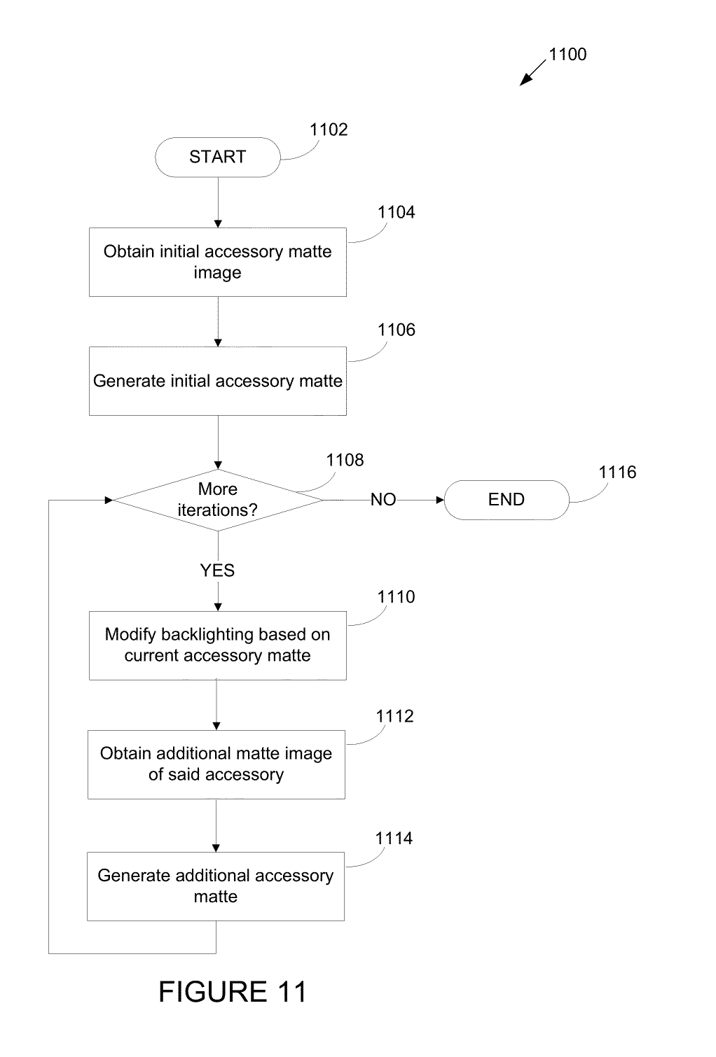

FIG. 11 illustrates a flowchart of an exemplary process for iterative matte refining in accordance with systems and methods for simulating accessory display on a subject. Process 1100 begins at step 1102.

Processing continues to step 1104, where an initial accessory matte image is obtained. The initial accessory matte image may be obtained using an initial backlight pattern. In one or more embodiments, the initial backlight pattern is a full monitor or a predefined subset of the monitor. The initial backlight pattern may be a uniform or varied intensity.

Processing continues to step 1106, where an initial accessory matte is generated. The initial accessory matte includes at least a portion of the full accessory image. In one or more embodiments, the initial accessory matte is generated based on image intensity in the accessory image. For example, a histogram may be used to detect the backlighting, and the initial accessory matte may include darker regions of the full accessory image.

Processing continues to decision step 1108, where it is determined whether to perform more iterations. The number of iterations may be a predetermined variable, determined based on manual inspection, or determined based on meeting preset conditions. The conditions may be determined based on image processing techniques.

If more iterations are to be performed, processing continues to step 1110, where the backlighting is modified based on a current accessory matte. In one or more embodiments, the backlight pattern is modified to more tightly converge with a silhouette of the accessory.

Processing continues to step 1112, where at least one additional matte image of the accessory is obtained. The at least one additional matte image of the accessory is obtained using the modified backlighting.

Processing continues to step 1114, where at least one at least one additional accessory matte is generated based on said at least one additional matte image.

Returning to decision step 1108, if no more iterations are to be performed, processing continues to step 1116, where process 1100 terminates.

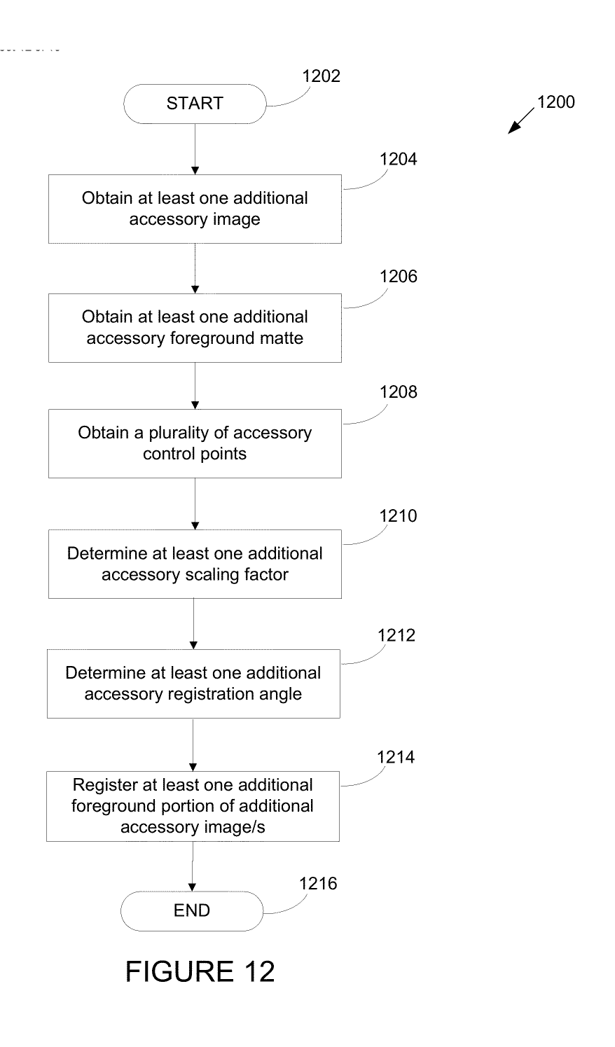

FIG. 12 illustrates a flowchart of an exemplary process for simulating display of an additional accessory in accordance with systems and methods for simulating accessory display on a subject. Process 1200 begins at step 1202.

Processing continues to step 1204, where at least one additional accessory image is obtained. The additional accessory image includes an additional accessory that will be simulated on the subject along with a first accessory.

Processing continues to step 1206, where at least one additional accessory foreground matte is obtained. The accessory foreground matte includes data that identifies a foreground portion of the additional accessory image that contains the additional accessory.

Processing continues to step 1208, where a plurality of additional control points associated with a additional accessory are obtained. The plurality of additional accessory control points is associated with at least one additional contour contact zone are associated with the additional accessory.

Processing continues to step 1210, where at least one additional accessory scaling factor is determined. For each of digital image of the subject, the additional accessory scaling factor may be the same or different than the accessory scaling factor for the first accessory. In one or more embodiments, the additional accessory image and the first accessory image are standardized, so no additional accessory scaling factor is necessary.

Processing continues to step 1212, where at least one additional accessory registration angle is determined. For each digital image of the subject, the additional accessory registration angle may be the same as or different from the accessory registration angle of the first accessory. The additional accessory registration angle may be associated with either or both of the additional accessory image and the digital image of the subject.

Processing continues to step 1214, where at least one foreground portion of the additional accessory image is registered with the digital image of the subject and the foreground portion of the accessory image.

Processing continues to step 1216, where process 1200 terminates.

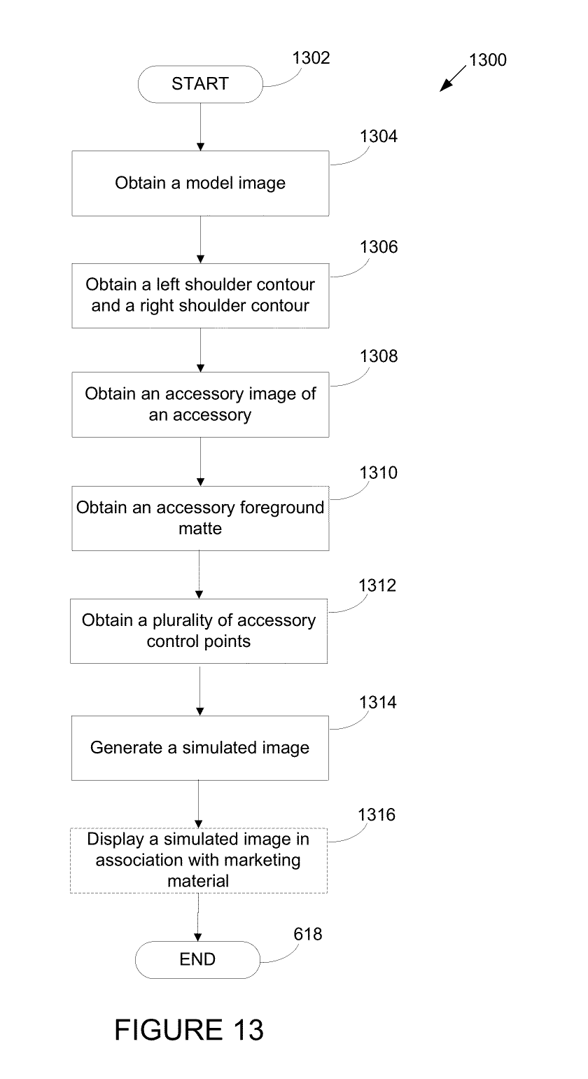

FIG. 13 illustrates a flowchart of an exemplary process for simulating display of at least one accessory on a model in accordance with systems and methods for simulating accessory display on a subject. Process 1300 begins at step 1302.

Processing continues to step 1304, where a model image is obtained. The model image includes a neck and upper chest region of the subject. In one or more embodiments, the subject is a commercial model.

Processing continues to step 1306, where a left shoulder contour and a right shoulder contour of the subject is obtained. The left shoulder contour and the right shoulder contour may be determined using image processing techniques.

Processing continues to step 1308, where an accessory image of an accessory is obtained. In one or more embodiments, the accessory is in accessory design for wearing on the neck area, such as a necklace, a choker, a scarf, a chain, a tie, or any other accessory suitable for wearing on the neck area. The accessory image may be selected from a set of images corresponding to a set of accessories offered for sale. The set of accessories may correspond to a product line, a brand, a wholesale store, a retail store, or any combination thereof.

Processing continues to step 1310, where an accessory foreground matte is obtained. The accessory foreground that defines a foreground region of the accessory in the accessory image.

Processing continues to step 1312, were a plurality of accessory control points are determined. The plurality of additional accessory control points is associated with at least one contour contact zone are associated with the accessory.

Processing continues to step 1314, where a simulated image of the subject wearing the accessory is generated. The simulated image is generated by registering a foreground portion of the accessory image with the digital image of the subject. The at least one accessory scaling factor, at least one accessory registration angle, accessory foreground matte, at least one target contour, and plurality of accessory control points are used to generate the simulated image. In one or more embodiments, the simulated image is generated using a compositing process, which may involve alpha blending. In one or more embodiments, the placement of the accessory image with respect to the subject image is based on uniform scaling and translation to rigidly place the accessory on the subject image followed by non-rigidly warping of the accessory image layer to corresponding necklace-shoulder contact points.

Processing continues to optional step 1316, where the simulated image is displayed in association with marketing material for the accessory. In one or more embodiments, the simulated image is displayed in conjunction with other simulated images for associated accessories, such as accessories belonging to the same line and/or brand, or accessory sold by the same wholesaler retailer. In one or more embodiments, the simulated image is displayed on an e-commerce website. The simulated image may also be displayed in a printed publication, a video, or in any other medium.

Image Generation Examples

At least one simulated image may be generated by registering a foreground portion of an accessory image with at least one digital image of the subject. The at least one accessory scaling factor, at least one accessory registration angle, accessory foreground matte, at least one target contour, and plurality of accessory control points are used to generate the at least one simulated image. As used herein, the term “register” refers to any alignment and combining of two or more portions of distinct images to render an output image.

The following non-limiting examples are directed to the simulation of a necklace on a subject image in accordance with the systems and methods for simulating accessory display on a subject described herein.

### Example 1

### Initial Accessory Placement

Necklaces images are acquired at a high resolution (2848×4288), which typically exceeds the resolution of user-uploaded images An approximately invariant property of images of humans is used to scale down the necklace to fit the user image as described below.

Necklace images are uniformly scaled by s=IPD(user)/IPD(necklace) where IPD is the Euclidean distance between the eye centers as measured in the image, often in units of pixels. The centers of the user-uploaded photo are manually specified by a user or automatically detected using an automatic detection algorithm while the centers of the eyes in the necklace image are specified by a one-time calibration step. A single reference necklace image, whose eye points are manually pre-specified, is transformed into the coordinate system of each necklace image by a homography. After scaling, the necklace is translated to the position in the user image that minimizes the sum of distances between corresponding necklace-shoulder contact points. Minimization is computed in a least-squares manner.

Note that if the face is non-frontal, the separation of the eyes as measured in the images is foreshortened. Using an estimate of head pose in the image and the mean IPD, the scale can be estimated. s=IPD(user)cos(HeadAngle)/IPD(necklace), where HeadAngle is the estimated angle of rotation of the head about an axis aligned with the intersection of the sagittal and coronal planes, and where zero head angle corresponds to the coronal plane being orthogonal to the camera's viewing direction.

### Example 2

### Estimating Necklace-to-Shoulder Point Correspondences

Following uniform scaling and translation to rigidly place the necklace on the target photo, there may be gaps between the ends of the necklace and shoulder contour. Our system closes the gap by non-rigidly warping the necklace layer to corresponding necklace-shoulder contact points. A moving least squares warp is constructed, which is chosen for its ability to maintain local rigidity (important for preserving the shape of rigid portions of the accessory such as a pendant on a necklace) in contrast with other warps which have global effects (e.g. affine and thin-plate splines). The warp is defined by point correspondences between (a) necklace-shoulder contact points detected in the alpha photo and (b) corresponding point estimate along the shoulder contours of the target subject photo. Computing necklace-shoulder contact points is performed once per necklace.

Each target subject photo is labeled with additional information to support our fitting and rendering process. In addition to verifying the automatically detected centers of the pupils, used for scaling the jewelry to match inter-pupillary distances between necklace and subject photos, a 1D curve and origin point are specified for both left and right shoulders. The necklace-shoulder contact points acquired with each necklace are constrained to lie along the left and right shoulder curves in order to minimize gap and overlap artifacts depicted in FIG. 2. A single control point corresponding to the bottom-most foreground pixel in the necklace alpha matte is also added to the warp in order to pin the bottom of the necklace to its rigidly placed position on initialization. Furthermore, the top-most necklace-shoulder contact point is constrained to match the origin point, enabling the user to ride the necklace up and down the shoulders by selecting different points along the target photo contours as the origin points.

At render time, the system executes the following greedy 1D curve matching procedure to establish correspondences between necklace-shoulder contact points and points along the piece-wise linear shoulder contours. First, both input (necklace-shoulder contact points) and output (target shoulder contours) points are transformed into a 1D curve domain by scanning both sets of points in curve-following order (top to bottom) and computing the distance between each successive pair in the output target photo's coordinate system (scale). The top-most input point is set to correspond with the origin point in target contour. For each necklace-shoulder contact point, the closest target shoulder point is chosen as a match in terms of curve distance from origin and removed from match candidacy, thus ensuring one-to-one correspondence between the curves. This greedy process works well in practice because the target shoulder contours are densely sampled and thus provide a large set of good candidate matches to input necklace-shoulder contact points.

### Example 3

### Shadow Composition

After establishing the set of point correspondences, the moving least squares image deformation is constructed and applied to the rigidly scaled, rotated and translated necklace and its alpha matte to bring them to the target photo coordinate system. Following necklace alpha matte warping, a copy of the alpha matte is blurred (Gaussian blurring, or other types of blurring), shifted by an offset that may be a function of IPD and composited as a translucent shadow (30% opacity is selected) before compositing the final color necklace atop the shadow.

While the invention herein disclosed has been described by means of specific embodiments and applications thereof, numerous modifications and variations could be made thereto by those skilled in the art without departing from the scope of the invention set forth in the claims.

What is claimed is:

1. A computer-readable medium comprising computer-readable instructions for simulating accessory display on a subject, wherein execution of said computer-readable instructions by one or more processors causes said one or more processors to carry out steps comprising:
obtaining at least one digital image of a subject comprising an accessory target zone;
identifying at least one target contour in said accessory target zone of said at least one digital image;
obtaining an accessory image comprising an accessory;
obtaining an accessory foreground matte;
obtaining a plurality of accessory control points associated with at least one contour contact zone;
determining at least one accessory scaling factor;
determining at least one accessory registration angle based on said at least one digital image of said subject; and
generating at least one simulated image by registering a foreground portion of said accessory image with said at least one digital image based on said at least one accessory scaling factor, said at least one accessory registration angle, said accessory foreground matte, said at least one target contour, and said plurality of accessory control points, wherein registering comprises applying a transformation.

2. The computer-readable medium of claim 1, wherein said transformation comprises a moving least squares morphing image deformation.

3. The computer-readable medium of claim 1, wherein said accessory target zone comprises a neck region.

4. The computer-readable medium of claim 1, wherein said accessory comprises an accessory selected from the group consisting of hats, bracelets, necklaces, scarves, purses, handbags, backpacks, watches, jewelry, form-fitting accessories, form-fitting clothing and undergarments.

5. The computer-readable medium of claim 4, wherein said at least one target contour comprises a left shoulder contour and a right shoulder contour.

6. The computer-readable medium of claim 1, wherein said accessory image comprises at least one reference marker.

7. The computer-readable medium of claim 6, wherein said at least one accessory scaling factor is determined based on said at least one reference marker and at least one inter-pupillary distance in said at least one digital image.

8. The computer-readable medium of claim 6, wherein said at least one reference marker comprises at least one reference color.

9. The computer-readable medium of claim 1, wherein said steps further comprise determining an image color distribution of said digital image, wherein said registering is further based on said image color distribution.

10. The computer-readable medium of claim 1, wherein said steps further comprise obtaining at least one material movement attribute associated with at least one portion of said accessory foreground matte, wherein said transformation is further based on said at least one material movement attribute.

11. The computer-readable medium of claim 1, wherein said steps further comprise obtaining at least one material appearance attribute corresponding to at least one portion of said accessory foreground matte, wherein said generation is further based on said at least one material appearance attribute.

12. The computer-readable medium of claim 11, wherein said at least one material appearance attribute comprises at least one attribute selected from the set consisting of transparency, surface angle and surface reflectivity.

13. The computer-readable medium of claim 1, wherein said at least one digital image comprises a plurality of video frames.

14. The computer-readable medium of claim 13, wherein said steps further comprise obtaining at least one sway point associated with said accessory foreground matte, wherein said transformation is further based on said at least one sway point and at least one estimated sway position of said accessory in said plurality of video frames.

15. The computer-readable medium of claim 1, wherein said accessory image and said accessory foreground matte are prepared by:
placing said accessory on a mannequin comprising a transparent surface;
providing backlighting with respect to an imaging device positioned to face said front chest area of said mannequin, wherein said backlighting is detectable through said transparent surface by said imaging device;
using said imaging device to capture a full accessory image; and
generating an initial accessory matte based on image intensity in said accessory image,
wherein said accessory image comprises at least a portion of said full accessory image and wherein said accessory foreground matte is based on said initial accessory matte.

16. The computer-readable medium of claim 15, wherein said mannequin further comprises a dampening portion configured to reduce movement of said accessory.

17. The computer-readable medium of claim 15, wherein said backlighting is configured to illuminate an area corresponding to a maximum accessory target zone.

18. The computer-readable medium of claim 15, further comprising the steps of
obtaining a manual mask prepared by a user based on said full accessory image, wherein said manual mask overlaps with said accessory in said full accessory image;
determining a manual mask edge based on said manual mask; and
determining an intersection between said manual mask edge and said initial accessory matte,
wherein one or more of said plurality of accessory control points is based on said intersection.

19. The computer-readable medium of claim 15, further comprising the step of iteratively refining said accessory image matte by:
modifying said backlighting based on a current accessory matte;
obtaining at least one additional matte image of said accessory; and
generating at least one additional accessory matte based on said at least one additional matte image.

20. The computer-readable medium of claim 19, further comprising the step of obtaining at least one updated full accessory image using said modified backlighting.

21. The computer-readable medium of claim 15, wherein at least one reference marker is placed in a known position with respect to said mannequin.

22. The computer-readable medium of claim 15, wherein said steps further comprise manually modifying said accessory foreground matte.

23. The computer-readable medium of claim 15, wherein said steps further comprise:
displaying said at least one simulated image in a user interface;
accepting at least one modification to at least one of said accessory scaling factor, said accessory registration angle, said inter-pupillary distance, and said at least one target contour; and
generating at least one modified simulated image based on said at least one modification.

24. The computer-readable medium of claim 1, wherein said steps further comprise displaying said at least one simulated image in association with marketing material for said accessory.

25. The computer-readable medium of claim 1, wherein said steps further comprise:
obtaining at least one additional accessory image comprising at least one additional accessory;
obtaining at least one additional accessory foreground matte;
obtaining a plurality of additional accessory control points associated with said at least one additional accessory foreground matte;
determining at least one additional accessory scaling factor; and
determining at least one additional accessory registration angle based on said at least one digital image of said subject,
registering at least one foreground portion of said at least one additional accessory image with said at least one digital image and said foreground portion of said accessory image.

26. A computer-readable medium comprising computer-readable instructions for generating and displaying model accessory images, wherein execution of said computer-readable instructions by one or more processors causes said one or more processors to carry out steps comprising:
obtaining a model image comprising a neck and upper chest region of a subject;
obtaining a left shoulder contour and a right shoulder contour of said subject in said model image;
obtaining an accessory image of an accessory for a neck area;
obtaining an accessory foreground matte defining a foreground region of said accessory in said accessory image;
obtaining a plurality of accessory control points associated with at least one contour contact zone;
generating a simulated image by registering a foreground portion of said accessory image with said model image based on said accessory foreground matte, said at least one target contour, and said plurality of accessory control points, wherein registering comprises applying a transformation based on said plurality of accessory control points and said at least one target contour; and
displaying said simulated image in association with marketing material for said accessory.
